(19) United States
(12) Patent Application Publication
(10) Pub. No.: US 2005/0219563 A1
(43) Pub. Date: Oct. 6, 2005

(54) Printing system, printing device, and printing method

(76) Inventor: Toshiaki Kakutani, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 10/871,507

(22) Filed: Jun. 18, 2004

(30) Foreign Application Priority Data
Jun. 20, 2003 (JP) 2003-176401

(51) Int. Cl. H04N 1/405; H04N 1/52; B41J 2/205

(52) U.S. Cl. 358/1.9; 358/3.16; 347/12; 347/15; 358/535

(57) ABSTRACT

A printing system of the invention sets each pixel group having a predetermined number of multiple pixels, determines a number of dots to be created in the pixel group, and supplies the determined number of dots as number data to a printing device. The printing device converts the received number data into dot data representing a dot on-off state in each pixel and stores only a relevant part of the dot data into a buffer. A head is driven according to the dot data stored in the buffer to print an image. The relevant part of the dot data stored in the buffer regards only pixels that are processed simultaneously by each reciprocating motion of the head for dot creation. This arrangement does not require storage of the dot data with regard to all the pixels, thus desirably attaining high-speed printing of a resulting image while advantageously saving the storage capacity required for the printing device.

### BACKGROUND

The present invention relates to a technique of making image data subjected to a preset series of image processing and printing a processed image. More specifically the invention pertains to a technique of attaining high-speed image printing by promptly transferring processed image data to a printing device.

### RELATED ART

Printing devices that create dots on a printing medium to print an image have widely been used as output devices of various imaging equipment. In such printing devices, an image is generally processed in units of small divisional areas called pixels, and dots are created in these pixels. The printing device takes only either of a dot-on state and a dot-off state in individual pixels, but gives dense dot areas and sparse dot areas over the whole image. For example, in the case of creating black ink dots on printing paper, dense dot areas are expressed as darker areas, while sparse dot areas are expressed as brighter areas. Adequate regulation of the dot formation densities corresponding to the tone values of an object image to be expressed thus ensures printing of a desired multi-tone image.

A typical method adopted in the printing device to create dots at adequate densities corresponding to the tone values of the image makes an object image subjected to a preset series of image processing and converts image data into dot data representing the dot on-off state in respective pixels. Optimum image processing of the object image generates the dot data for creation of dots at adequate densities corresponding to the tone values of the image data. The dot data representing the dot on-off state thus generated is then supplied to the printing device. The printing device actually creates dots in the respective pixels according to the received dot data. This procedure creates dots at adequate densities corresponding to the tone values of the image data to print a desired image.

This prior art image printing method, however, undesirably requires a long transfer time of the processed image data with an increase in number of pixels and accordingly fails in high-speed image printing. The total number of pixels constituting an image tends to significantly increase with the recent demands for the enhanced picture quality and the size growth (see, for example, Japanese Patent Laid-Open Gazette No. 2000-115716A). The higher resolution of an image interferes with high-speed printing of the image.

### SUMMARY

The object of the invention is thus to eliminate the drawbacks of the prior art technique and to provide a technique of attaining high-speed printing of an image without increasing the storage capacity required for a printing device.

In order to attain at least part of the above and the other related objects, the present invention is directed to a printing system that includes an image processing device and a printing device.

The image processing device makes image data subjected to a preset series of image processing. The image processing device includes: a dot number determination module that determines a number of dots to be created in each pixel group, which is set to have a predetermined number of multiple pixels included in an image, according to the image data; and a number data output module that outputs number data, which represents the determined number of dots to be created in the pixel group, to the printing device.

The printing device creates dots based on a result of the preset series of image processing executed by the image processing device, so as to print a resulting image on a printing medium. The printing device includes: a head that makes a reciprocating motion relative to the printing medium to create plural dots simultaneously at predetermined intervals and repeats the reciprocating motion a preset number of times to complete a raster line as an array of aligned dots; a pixel set detection module that detects plural pixels, which are processed simultaneously by each reciprocating motion of the head for dot creation, and specifies the detected plural pixels as a pixel set corresponding to the reciprocating motion of the head; a number data storage module that receives and stores the output number data; a dot data storage module that converts the stored number data into dot data representing a dot on-off state in each pixel, and stores the dot data with regard to the respective pixels included in the specified pixel set; a dot data supply module that supplies the stored dot data to the head in synchronism with the reciprocating motion of the head; and a dot creation module that drives the head according to the supplied dot data, so as to create dots on the printing medium.

There is a printing method corresponding to the printing system of the invention. The invention is thus directed to a printing method that prints an image. The printing method drives a head, which makes a reciprocating motion relative to a printing medium to create plural dots simultaneously at predetermined intervals, according to image data and repeats the reciprocating motion a preset number of times to complete a raster line as an array of aligned dots.

The printing method includes the steps of: determining a number of dots to be created in each pixel group according to the image data, where the pixel group is set to have a predetermined number of multiple pixels included in the image; storing the determined number of dots with regard to the pixel group; detecting plural pixels, which are processed simultaneously by each reciprocating motion of the head for dot creation, and specifying the detected plural pixels as a pixel set corresponding to the reciprocating motion of the head; generating dot data representing a dot on-off state in each pixel, based on the number of dots stored with regard to the pixel group and storing the dot data of the respective pixels included in the specified pixel set; supplying the stored dot data to the head in synchronism with the reciprocating motion of the head; and driving the head according to the supplied dot data, so as to create dots on the printing medium.

The printing system and the corresponding printing method of the invention detect plural pixels, which are processed simultaneously by each reciprocating motion of the head for dot creation, and specify the detected plural pixels as a pixel set corresponding to the reciprocating motion. The printing system and the corresponding printing method then generate the dot data representing the dot on-off state in each pixel, based on the number of dots to be created in the pixel group, and store the dot data only with regard to the respective pixels included in the specified pixel set. The stored dot data is supplied to the head in synchronism with the reciprocating motion of the head. The head is driven according to the supplied dot data to create dots and print a resulting image on the printing medium.

The arrangement of the invention does not require storage of the dot data with regard to all the pixels included in each pixel group. Requirement is storage of the dot data with regard to only the pixels that are processed simultaneously by each reciprocating motion of the head for dot creation. This significantly saves the storage capacity required for the printing device to print the image.

In the printing system of the invention that generates the dot data from the number of dots to be created in each pixel group, one preferable procedure determines dot-on pixels, in which dots are to be created, based on ordinal numbers allocated to the respective pixels in the pixel group for dot creation.

The ordinal numbers allocated to the respective pixels in each pixel group for dot creation, that is, information on the dot creation order of the respective pixels in each pixel group, advantageously facilitates generation of the dot data from the number of dots to be created in the pixel group.

In the printing system of the invention that stores the dot data with regard to the respective pixels included in the specified pixel set, that is, the dot data with regard to the plural pixels that are processed simultaneously by the reciprocating motion of the head for dot creation, one preferable procedure generates the dot data with regard to all the pixels included in each pixel group and subsequently stores the dot data with regard to only the respective pixels in the specified pixel set selected among the generated dot data.

This procedure stores the dot data with regard to only the relevant pixels selected among the generated dot data, thus advantageously simplifying the processing.

Another preferable procedure selects the pixels included in the specified pixel set, generates the dot data with regard to these pixels, and stores the generated dot data.

This procedure generates the dot data with regard to only the relevant pixels and does not require generation of dot data with regard to all the pixels included in each pixel group. This arrangement desirably saves the storage capacity for the generated dot data and attains the high-speed processing.

In order to eliminate the drawbacks of the prior art technique, the present invention is also directed to a printing device that prints an image. The printing device includes: a head for printing that makes a reciprocating motion relative to a printing medium to create plural dots simultaneously at predetermined intervals and repeats the reciprocating motion a preset number of times to complete a raster line as an array of aligned dots; a number data storage module that receives and stores number data representing a number of dots to be created in each pixel group, which is set to have a predetermined number of multiple pixels included in the image; a pixel set detection module that detects plural pixels, which are processed simultaneously by each reciprocating motion of the head for dot creation, and specifies the detected plural pixels as a pixel set corresponding to the reciprocating motion of the head; a dot data storage module that converts the stored number data into dot data representing a dot on-off state in each pixel, and stores the dot data with regard to the respective pixels included in the specified pixel set; a dot data supply module that supplies the stored dot data to the head in synchronism with the reciprocating motion of the head; and a dot creation module that drives the head according to the supplied dot data, so as to create dots on the printing medium.

There is a printing method corresponding to the printing device of the invention. The invention is thus directed to a printing method that prints an image. The printing method makes a reciprocating motion of a head relative to a printing medium to create plural dots simultaneously at predetermined intervals and repeats the reciprocating motion a preset number of times to complete a raster line as an array of aligned dots.

The printing method includes the steps of: receiving and storing number data representing a number of dots to be created in each pixel group, which is set to have a predetermined number of multiple pixels included in the image; detecting plural pixels, which are processed simultaneously by each reciprocating motion of the head for dot creation, and specifying the detected plural pixels as a pixel set corresponding to the reciprocating motion of the head; converting the stored number data into dot data representing a dot on-off state in each pixel, and storing the dot data with regard to the respective pixels included in the specified pixel set; supplying the stored dot data to the head in synchronism with the reciprocating motion of the head; and driving the head according to the supplied dot data, so as to create dots on the printing medium.

The printing device and the corresponding printing method of the invention generates the dot data with regard to the respective pixels, based on the number of dots to be created in each pixel group and drives the head according to the dot data to print a resulting image. The stored dot data regards only the pixels that are simultaneously processed by one reciprocating motion of the head for dot creation. The image is printed according to the dot data supplied to the head.

This arrangement does not require storage of the dot data with regard to all the pixels included in each pixel group, thus desirably saving the required storage capacity.

In the printing device and the printing method of the invention that generate the dot data from the number of dots to be created in each pixel group, one preferable procedure determines dot-on pixels, in which dots are to be created, based on ordinal numbers allocated to the respective pixels in the pixel group for dot creation.

The ordinal numbers allocated to the respective pixels in each pixel group for dot creation advantageously facilitates generation of the dot data from the number of dots to be created in the pixel group.

The technique of the invention is also actualized by a computer that reads a program for attaining any of the printing methods discussed above. Other possible applications of the invention include recording media in which such programs corresponding to the printing methods are recorded, as well as programs corresponding to the printing devices discussed above and recording media in which such programs are recorded.

The computer reads any of these programs and the equivalent programs recorded in the recording media to attain the various functions described above, thus attaining high-speed image printing while desirably saving the storage capacity required for the printing device.

### BRIEF DESCRIPTION OF THE DRAWINGS

FIG. 1 shows a printing system including a printing device in one mode of the invention;

FIG. 2 illustrates the configuration of a computer as a print control device in one embodiment of the invention;

FIG. 3 schematically illustrates the structure of a printer in the embodiment;

FIG. 4 shows multiple nozzles for ejecting ink droplets, which are formed on the bottom faces of ink ejection heads of respective colors;

FIG. 5 conceptually shows a mechanism how the ink ejection heads eject ink droplets in response to supply of a drive signal and control data;

FIG. 6 is a flowchart showing a processing routine of generating control data and printing an image according to the control data (image printing process) in the embodiment;

FIG. 7 shows an example of the resolution conversion process executed in the embodiment;

FIG. 8 is a flowchart showing the details of the number data generation process;

FIG. 9 shows part of a dither matrix;

FIG. 10 conceptually shows determination of the dot on-off state with respect to each target pixel, based on the dither matrix;

FIG. 11 conceptually shows conversion of number data into dot data;

FIG. 12 is a flowchart showing the details of the number data decoding process of the embodiment;

FIG. 13 conceptually shows a process of forming one raster line by two reciprocating motions (that is, by 2 passes);

FIG. 14 conceptually shows a process of forming one raster line by 4 passes;

FIG. 15 conceptually shows selection of an object pixel group including a target pixel in the system of completing one raster line by 2 passes;

FIG. 16 conceptually shows selection of an object pixel group including a target pixel in the system of completing one raster line by 4 passes;

FIG. 17 is a flowchart showing the details of processing to generate dot data according to number data;

FIG. 18 conceptually shows generation of dot data according to number data;

FIG. 19 is a flowchart showing a dot data generation process in a first modification; and

FIG. 20 conceptually shows conversion of number data into dot data in a second modification.

### DESCRIPTION OF THE PREFERRED EMBODIMENTS

The invention is described in detail with reference to a preferable embodiment in the following sequence, in order to clarify the features, aspects, and effects of the invention:
A. Subject of Embodiments
B. System Configuration
C. Outline of Image Printing Process
D. Number Data Generation Process
E. Number Data Decoding Process
F. Modifications

### A. Subject of Embodiments

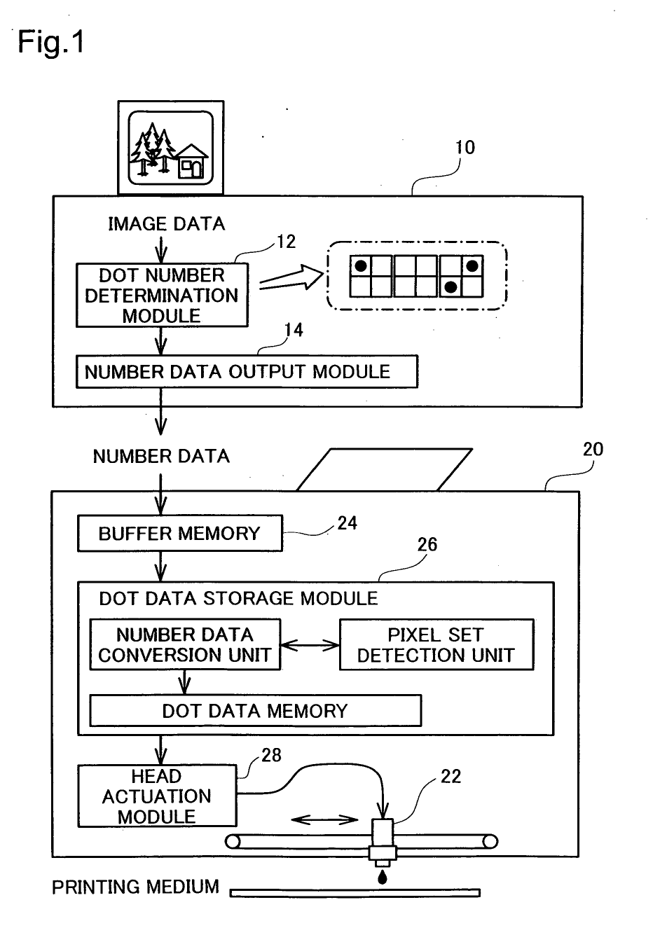

The general outline of a mode of the invention is described with reference to FIG. 1, prior to detailed description of a preferred embodiment. A printing system of the invention shown in FIG. 1 includes a computer 10 functioning as an image processing device and a printer 20 and functioning as a printing device. A predetermined program is loaded to and executed by the computer 10, and the computer 10 and the printer 20 integrally function as the printing system. The printer 20 has a head 22 to eject small ink droplets. Adequate ejection of ink droplets from the head 22 onto a printing medium forms ink dots at arbitrary positions on the printing medium. The printer 20 takes advantage of this function and ejects ink droplets on the printing medium while reciprocating the head 22, so as to create ink dots in a desired distribution and thereby print a resulting image on the printing medium. Since the printer 20 creates ink dots to print a desired image, a preset series of image processing is required in advance to convert image data into dot data representing dot on-off state in respective pixels of the image. The computer 10, which is separate from the printer 20, generally takes charge of such image processing. The resulting processed data are supplied from the computer 10 to the printer 20 for printing an image.

In the printing system that uses the computer 10 to execute image processing and supply resulting data to the printer 20 for printing an image, an increase in number of pixels to increase the volume of image data undesirably extends the required time for supply of the data to the printer 20. This interferes with prompt printing of an image. The computer 10 included in the printing system of FIG. 1 thus collects a preset number of pixels into one pixel group, specifies the number of dots to be created in the pixel group, and supplies number data representing the specified number of dots to the printer 20. A dot number determination module 12 shown in FIG. 1 executes a preset series of image processing of an object image to be printed, so as to determine the numbers of dots to be created in the respective pixel groups.

A frame of one-dot chain line shown in the vicinity of the dot number determination module 12 conceptually shows a process of determining the numbers of dots to be created in respective pixel groups. Each small squire in the frame represents a pixel, and a closed circle in a pixel shows that a dot is to be created in the pixel. Dot-on pixels, in which dots are to be created, are determined by applying a known image processing technique, such as the error diffusion method or the dithering method, to image data. The dot number determination module 12 shown in FIG. 1 collects two columns and two rows of pixels, that is, four pixels, into one pixel group and determines the number of dots to be created in the pixel group. For example, in the frame of one-dot chain line, the determined number of dots to be created is 1 in a left most pixel group, 0 in a second left pixel group, and 2 in a right most pixel group. A number data output module 14 outputs the determined number of dots to be created in each pixel group as number data to the printer 20. Compared with the structure of outputting the dot on-off state with regard to each pixel, this arrangement of outputting the number of dots to be created in each pixel group desirably reduces the total volume of data, thus ensuring prompt supply of data to the printer 20.

The printer 20 converts the received number data into dot data representing the dot on-off state in each pixel and drives the head 22 according to the converted dot data, so as to print an image. The printer 20 shown in FIG. 1 does not immediately convert the number data received from the computer 10 into the dot data representing the dot on-off state in respective pixels, but once stores the received number data into a buffer memory 24. A dot data storage module 26 in the printer 20 successively converts the number data into the dot data, which represents the dot on-off state in the respective pixels, in synchronism with the motions of the head 22 that reciprocates on a printing medium to create dots, and stores the converted dot data with regard to only the pixels that are processed simultaneously for dot creation by the head 22, into a memory. The dot data storage module 26 includes a pixel set detection unit to detect plural pixels that are processed simultaneously by one reciprocating motion of the head 22 for dot creation as a pixel set among multiple pixels, a number data conversion unit to convert the number data into dot data representing the dot on-off state in the respective pixels, and a dot data memory to store the dot data with regard to only the pixels included in the detected pixel set. The number data conversion unit and the pixel set detection unit cooperate to convert the number data into the dot data and write the obtained dot data with regard to the pixels included in the detected pixel set into the dot data memory.

The head actuation module 28 reads the dot data from the dot data memory with the reciprocating motions of the head 22 and supplies the dot data to the head 22. The head 22 is then driven to create dots and print a resulting image on the printing medium.

In the printing system of FIG. 1, the dot data are stored with regard to only the pixels that are processed simultaneously by one reciprocating motion of the head 22. This arrangement does not require storage of dot data with regard to all the pixels included in each pixel group and thus significantly saves the storage capacity of the memory mounted on the printer 20. The printing system and the printer of this mode are discussed below in detail with reference to a preferred embodiment.

### B. System Configuration

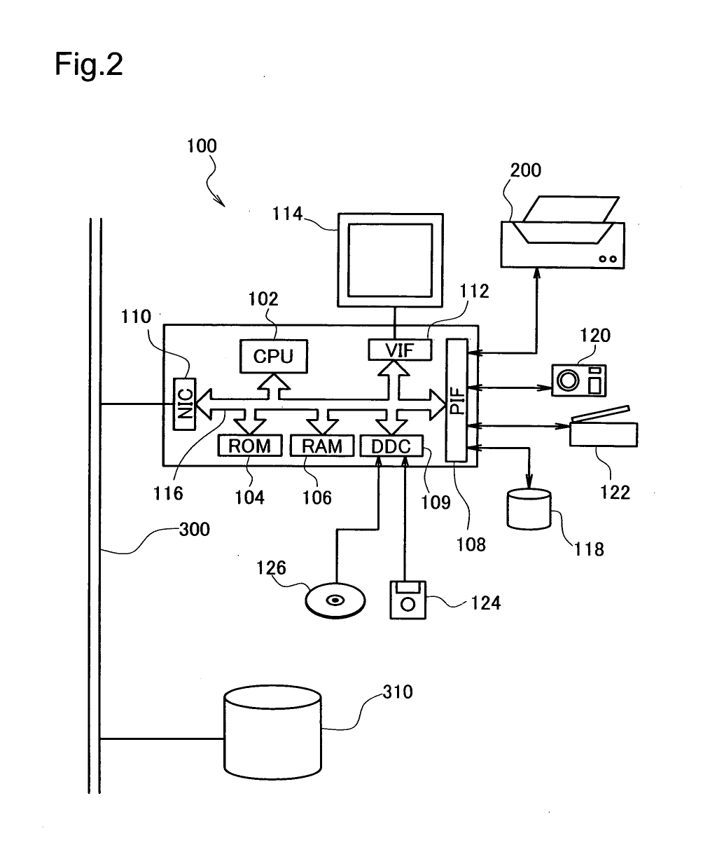

FIG. 2 illustrates the configuration of a computer 100 as a print control device in one embodiment of the invention. The computer 100 is a known computer including a CPU 102, a ROM 104, and a RAM 106 interconnected via a bus 116. The computer 100 has a disk controller DDC 109 to read data from, for example, a flexible disk 124 or a compact disc 126, a peripheral equipment interface PIF 108 to receive and send data from and to peripheral equipment, and a video interface VIF 112 to drive and actuate a CRT 114. The PIF 108 is connected with a printer 200 described later and a hard disk unit 118. Connection of a digital camera 120 or a color scanner 122 with the PIF 108 enables printing of images taken by the digital camera 120 or the color scanner 122. Insertion of a network interface card NIC 110 into the computer 100 causes the computer 100 to connect with a communication line 300 and obtain data stored in a storage device 310 linked to the communication line 300.

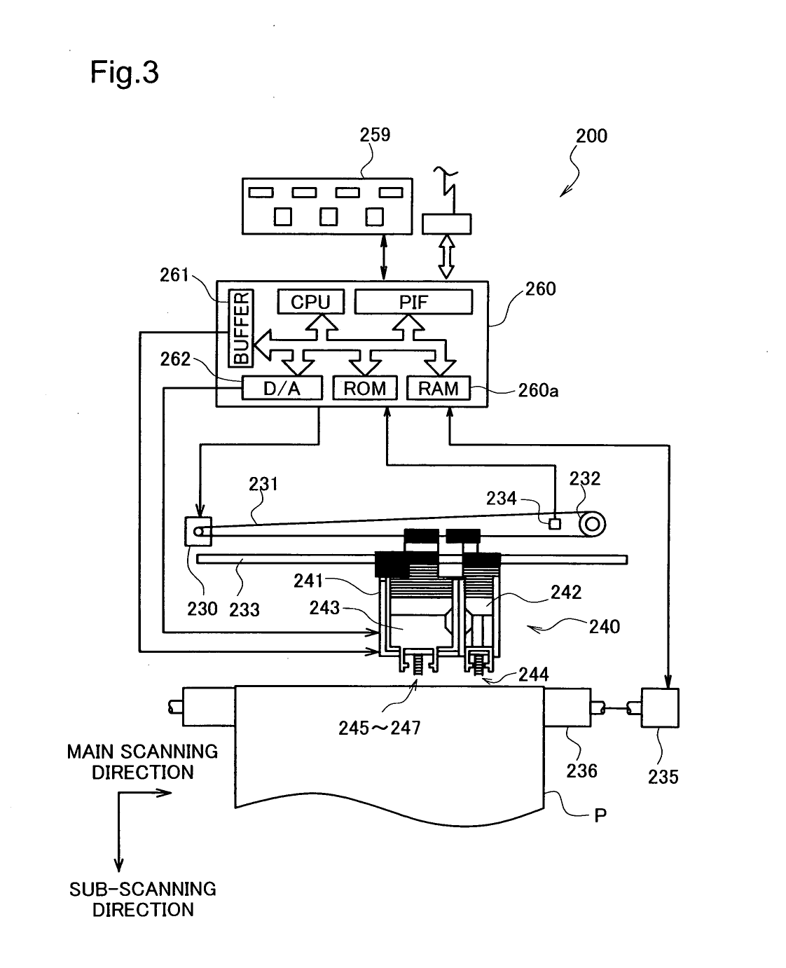

FIG. 3 schematically illustrates the structure of the printer 200 in this embodiment. The printer 200 is an inkjet printer that is capable of creating dots of four color inks, cyan, magenta, yellow, and black. The inkjet printer may be capable of creating dots of six color inks, cyan ink of a lower dye density (light cyan ink) and magenta ink of a lower dye density (light magenta ink), in addition to the above four color inks. In the description below, cyan ink, magenta ink, yellow ink, black ink, light cyan ink, and light magenta ink may be expressed simply as C ink, M ink, Y ink, K ink, LC ink, and LM ink, respectively.

As illustrated, the printer 200 has a mechanism of actuating a print head 241 mounted on a carriage 240 to eject inks and create dots, a mechanism of activating a carriage motor 230 to reciprocate the carriage 240 along a shaft of a platen 236, a mechanism of activating a paper feed motor 235 to feed printing paper P, and a control circuit 260 that controls the creation of dots, the shift of the carriage 240, and the feed of the printing paper P.

An ink cartridge 242 for storing the K ink and an ink cartridge 243 for storing the C, M, and Y inks are attached to the carriage 240. The respective inks in the ink cartridges 242 and 243 attached to the carriage 240 are supplied through non-illustrated ink conduits to corresponding ink ejection heads 244 through 247 of the respective colors formed on the bottom face of the print head 241. The ink ejection heads 244 through 247 of the respective colors eject ink droplets of the supplied inks to create ink dots on the printing medium.

The control circuit 260 includes a D/A converter 262 that converts digital data into analog signals and a drive buffer 261 that temporarily stores data to be supplied to the print head 241, in addition to a CPU, a ROM, a RAM 260a, and a peripheral equipment interface PIF. The control circuit 260 may alternatively have no CPU but actualize these functions by the hardware or firmware configuration. The control circuit 260 controls the operations of the carriage motor 230 and the paper feed motor 235 to regulate main scanning motions and sub-scanning motions of the carriage 240. The control circuit 260 also drives the print head 241 at adequate timings corresponding to the main scanning motions and the sub-scanning motions of the carriage 240. The print head 241 is driven, in response to supply of a drive signal from the D/A converter 262 and control data from the drive buffer 261. The mechanism of supplying the drive signal and the control data to drive the print head 241 and eject ink droplets will be discussed later with reference to another drawing. Under the control of the control circuit 260, ink droplets are ejected from the ink ejection heads 244 through 247 of the respective colors at adequate timings to create ink dots and print a color image on the printing paper P.

Any of diverse methods may be adopted to eject ink droplets from the ink ejection heads of the respective colors. One applicable method uses piezoelectric elements for ink ejection. Another applicable method uses heaters that are located in ink conduits and are actuated to produce bubbles in the ink conduits for ejection of ink droplets. The technique of this embodiment is not restricted to the ink ejection-type printers but may also be applied to printers that take advantage of thermal transfer to create ink dots on a printing medium and printers that take advantage of static electricity to make respective color toners adhere on a printing medium.

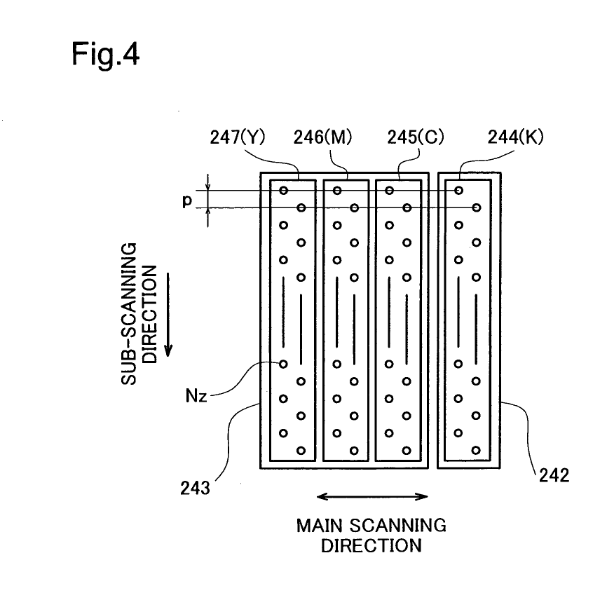

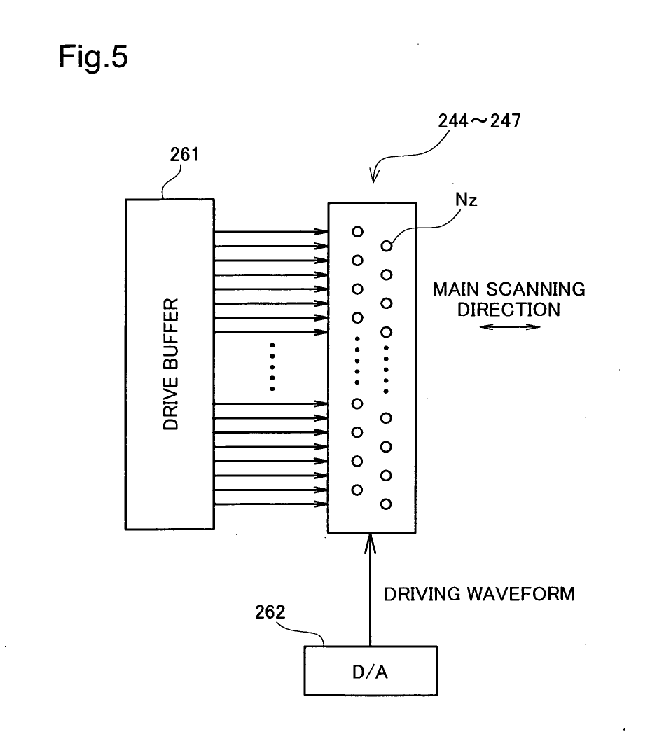

FIG. 4 shows multiple nozzles Nz for ejecting ink droplets, which are formed on the bottom faces of the ink ejection heads 244 through 247 of the respective colors. As illustrated, four nozzle arrays for ejecting respective color ink droplets are formed on the bottom faces of the ink ejection heads of the respective colors. Each nozzle array includes 48 nozzles Nz, which are arranged in zigzag at intervals of a nozzle pitch k. These nozzles simultaneously eject ink droplets, in response to the supply of the drive signal and the control data supplied from the control circuit 260. This mechanism is described below with reference to FIG. 5.

FIG. 5 conceptually shows the mechanism how the ink ejection heads 244 through 247 eject ink droplets in response to the supply of the drive signal and the control data. As shown in FIG. 4, the multiple nozzles Nz are formed in the bottom faces of the respective ink ejection heads and are respectively connected to the drive buffer 261. The drive signal output from the D/A converter 262 is simultaneously supplied to all the nozzles Nz. All the nozzles Nz are, however, not driven by the supply of the drive signal. Only the nozzles Nz with control data ‘1’, which is supplied from the drive buffer 261 to represent selected nozzles, are actually driven to eject ink droplets and create dots in response to the supply of the drive signal. Conversely the nozzles Nz with control data ‘0’, which is supplied from the drive buffer 261 to represent non-selected nozzles, are not actually driven to eject ink droplets in response to the supply of the drive signal. Namely among the multiple nozzles Nz formed in the ink ejection heads 244 through 247, only the nozzles Nz selected according to the control data are driven to eject ink droplets.

The control circuit 260 shown in FIG. 3 outputs the control data for controlling ejection of ink droplets and the drive signal to the ink ejection heads 244 through 247, synchronously with the main scanning motions and the sub-scanning motions of the carriage 240. Ink dots are thus created at adequate positions to print an image on the printing paper P.

### C. Outline of Image Printing Process

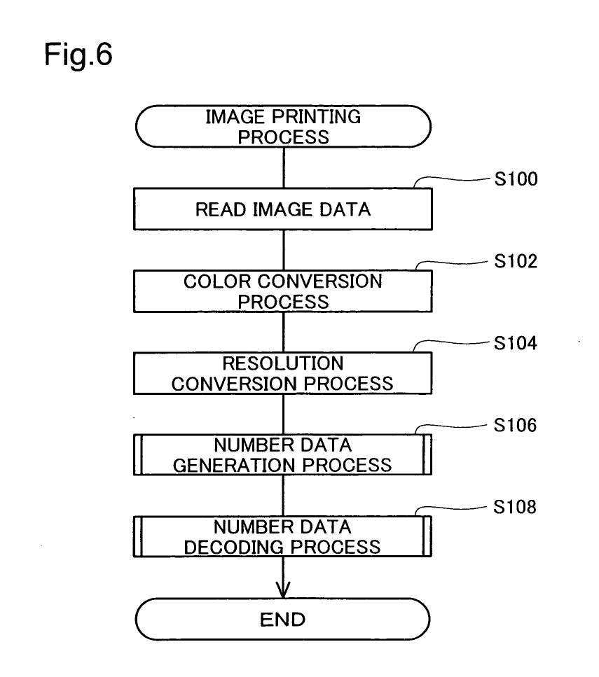

The control data used for controlling ejection of ink droplets are generated, when an object image to be printed goes through a preset series of image processing. FIG. 6 is a flowchart showing a processing routine of generating control data and printing an image according to the control data (image printing process) in this embodiment. The first half of the image printing process of this embodiment is executed by the internal CPU of the computer 100, whereas the latter half is executed by the internal CPU of the control circuit 260 in the printer 200. The general outline of the image printing process is described below with reference to the flowchart of FIG. 6.

When the image printing process starts, the computer 100 first reads object image data to be converted (step S100). The object image data is RGB color image data in this embodiment, although monochromatic image data may be replaced with the color image data.

The input color image data goes through a color conversion process (step S102). The color conversion process converts the RGB color image data expressed by combinations of tone values of the colors R, G, and B into image data expressed by combinations of tone values of respective colors used for printing. As mentioned above, the printer 20 prints an image with the four color inks C, M, Y, and K. The color conversion process of this embodiment accordingly converts the image data expressed by the tone values of the colors R, G, and B into image data expressed by the tone values of the four colors C, M, Y, and K. The procedure of color conversion refers to a three-dimensional numerical table called a color conversion table (LUT). The LUT stores a mapping of the tone values of the respective colors C, M, Y, and K to the RGB color image data. The color conversion is thus readily and promptly carried out by referring to this LUT.

The color-converted image data then goes through a resolution conversion process (step S104). The resolution conversion process converts the resolution of the image data into a resolution for printing with the printer 200 (printing resolution).

In general, size reduction of pixels to attain printing at the higher resolution effectively enhances the picture quality of resulting prints. The increased resolution of original image data is, however, not essential for the increased printing resolution. The dot printing process takes only either of a dot-on state or a dot-off state with respect to each pixel. Some printers adopt the variable-size dot printing system or the varying ink-density dot printing system to express a greater number of tones by the dots. Such printers are, however, capable of expressing only several tones in each pixel. The input image data of, for example, 1 byte, on the other hand, can express as many as 256 tones with respect to each pixel. Owing to such a significant difference in number of tones expressible in each pixel, simply setting a higher printing resolution than the resolution of the input image data leads to improvement in picture quality of resulting prints. On this basis, the processing of step S104 in the flowchart of FIG. 6 converts the resolution of the input image data into the higher printing resolution.

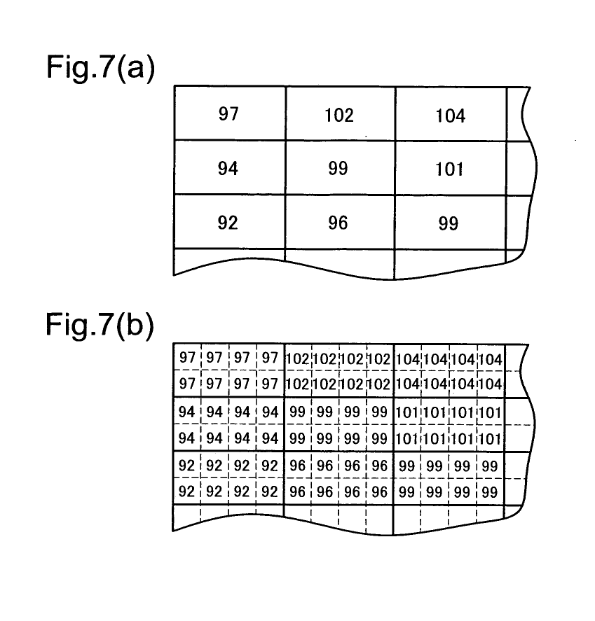

FIG. 7 shows an example of the resolution conversion process executed in this embodiment. The prior color conversion gives the image data of the C, M, Y, and K colors. The resolution conversion process discussed below is applied to the image data in any of these colors. For the simplicity of explanation, the color is not specified in the following description.

FIG. 7(a) shows part of color-converted image data. Each of multiple rectangles in FIG. 7(a) represents a pixel, and each numeral in the rectangle denotes a tone value allocated to the pixel. As illustrated, the color-converted image data has tone values allocated to the respective pixels arranged in lattice. One available method to increase the resolution of the image data creates new pixels by interpolation of existing pixels. The resolution conversion process of this embodiment, however, adopts the simplest technique of dividing each pixel into smaller pixels.

FIG. 7(b) shows division of pixels for conversion of the resolution. In the illustrated example, each pixel is divided into four in the main scanning direction (the horizontal direction in the drawing) and into two in the sub-scanning direction (the vertical direction in the drawing). Namely one pixel is divided into eight smaller pixels. The broken lines in each solid rectangle of FIG. 7(b) represent divisions of each pixel. The tone value allocated to the original pixel is assigned to all the smaller divisions of the pixel. Such division of pixels quadruples the resolution of the image data in the main scanning direction and doubles in the sub-scanning direction. The multiplication of resolution may be set arbitrarily according to the requirements.

After conversion of the resolution of the image data into the printing resolution, the computer 100 starts a number data generation process (step S106). The color-converted image data are tone data having tone values allocated to the respective pixels. The printer 200 creates dots in pixels at adequate densities corresponding to the tone values of the image data to print an image. The required procedure accordingly converts the tone data into dot data representing the dot on-off state in the respective pixels and transfers the dot data to the printer 200. Transfer of the dot data in units of individual pixels to the printer 200 undesirably extends the time required for transfer with an increase in number of pixels and thereby impedes prompt image printing. The image printing process of this embodiment thus sets pixel groups, each having a predetermined number of multiple pixels, and transfers dot number data representing the number of dots to be created in each pixel group to the printer 200 in units of pixel groups. One applicable procedure of generating the dot number data representing the number of dots to be created in each pixel group first converts image data into dot data representing the dot on-off state in respective pixels and then sets pixel groups, each having a predetermined number of multiple pixels. Another applicable procedure first sets pixel groups, each having a predetermined number of multiple pixels, and then determines the number of dots to be created in the pixels of each pixel group as discussed later. The number data generation process of step S106 generates the dot number data representing the number of dots to be created in each pixel group (hereafter referred to as the number data) and transfers the generated number data to the printer 200. The details of the number data generation process will be discussed later.

The internal CPU of the control circuit 260 in the printer 200 receives the number data output from the computer 100 and starts a number data decoding process (step S108). As mentioned above, the printer 200 prints an image according to the data representing the dot on-off state in the respective pixels. The computer 100 of the embodiment, however, outputs the number data representing the number of dots to be created in each pixel group, instead of the data representing the dot on-off state in the respective pixels. The printer 200 is thus required to convert the input number data into the data representing the dot on-off state in the respective pixels. In the specification hereof, the data representing the dot on-off state in the respective pixels is referred to as dot data. The method of converting number data into dot data will be discussed later. The obtained dot data is output as control data from the drive buffer 261 with the main scanning motions of the ink ejection heads 244 through 247. Ink droplets are accordingly ejected to print an image on the printing medium. Namely the number data decoding process converts the number data into dot data and outputs the dot data as control data from the drive buffer 261 synchronously with the main scans of the ink ejection heads 244 through 247. The number data decoding process of this embodiment does not store all the dot data obtained by conversion of the number data but stores the dot data with regard to only the pixels output as the control data from the driver buffer 261, in order to significantly save the memory capacity to be mounted on the printer 200, as discussed later in detail.

For convenience of explanation, the description regards the details of the number data generation process, the details of the number data decoding process of the embodiment, and the effects of the number data decoding process on reduction of the memory capacity to be mounted on the printer 200 in this sequence.

### D. Number Data Generation Process

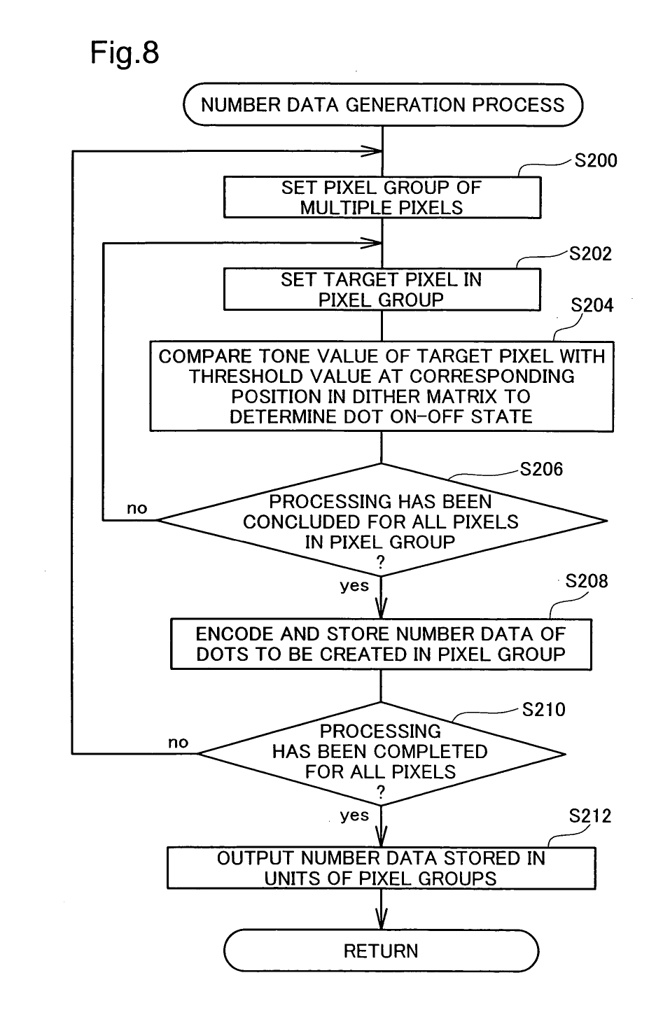

FIG. 8 is a flowchart showing the details of the number data generation process. The number data generation process is described with reference to this flowchart.

The number data generation process first sets a pixel group having a predetermined number of multiple pixels (step S200). The precedent resolution conversion process has divided one pixel into eight smaller pixels. In this embodiment, the eight smaller pixels obtained by division of one pixel are thus set as one pixel group. For example, one pixel on the upper left corner of FIG. 7(a) is divided into eight smaller pixels arranged vertically in four columns and horizontally in two rows as shown in the upper left corner of FIG. 7(b). These eight smaller pixels are set as one pixel group at step S200. The predetermined number of multiple pixels set as one pixel group may not be mutually adjoining pixels, but may be any pixels having a specified positional relation.

In the case of setting smaller pixels, which are obtained by division of one pixel, as one pixel group, the resolution conversion process (see FIG. 7) may be omitted from the image printing process of FIG. 6. In the case of such omission, the terminology ‘pixel group’ in the following description is to be replaced by ‘the pixel prior to resolution conversion’.

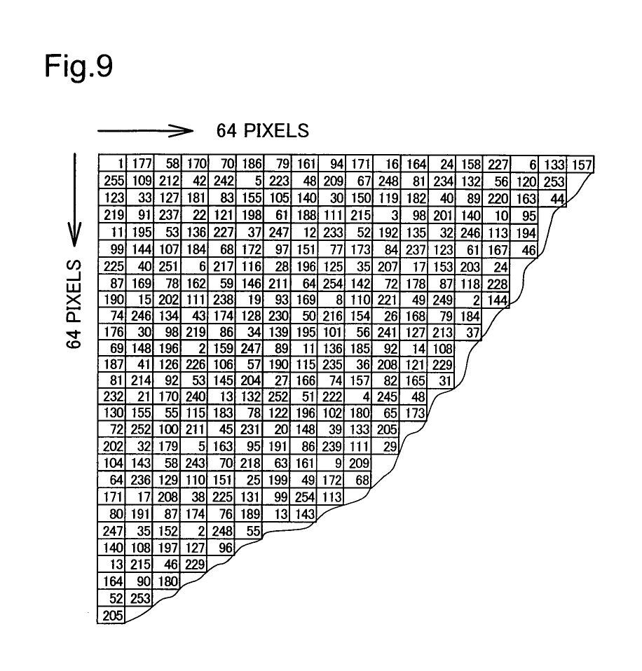

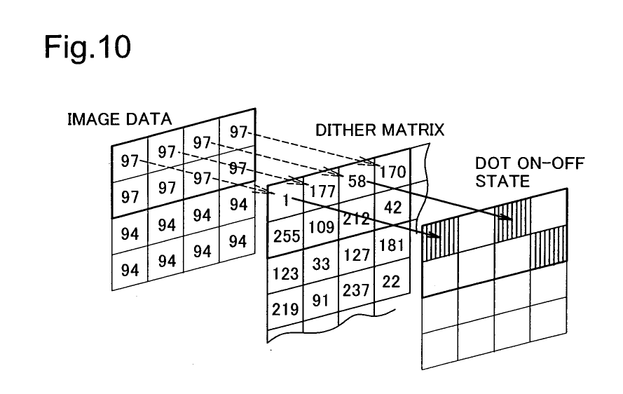

The number data generation process subsequently sets one object pixel, for which the dot on-off state is to be determined, (target pixel) among the predetermined number of multiple pixels set as one pixel group (step S202). The process then compares the tone value allocated to the target pixel with a threshold value stored at the corresponding position in a dither matrix to determine the dot on-off state with respect to the target pixel (step S204) The dither matrix is a two-dimensional numerical table that stores multiple threshold values arranged in lattice. The procedure of determining the dot on-off state based on a dither matrix is described with reference to FIGS. 9 and 10.

FIG. 9 shows part of a dither matrix. This dither matrix stores at random threshold values, which are selected throughout a tone value range of 0 to 255 and are allocated to a total of 4096 pixels of 64 pixels in length and 64 pixels in width. In this embodiment, the image data is 1-byte data and the tone value allocated to each pixel is in the range of 0 to 255, so that the threshold values in the dither matrix are selected in the tone value range of 0 to 255. The dither matrix is not restricted to the size of 64 pixels in both length and width as in the example of FIG. 9, but may have any desired size having different numbers of pixels in length and in width or having the same numbers of pixels in both length and width.

FIG. 10 conceptually shows determination of the dot on-off state with respect to each target pixel, based on the dither matrix. The procedure of determining the dot on-off state first compares the tone value of each target pixel with a threshold value stored at the corresponding position in the dither matrix. Each arrow of thin broken line in FIG. 10 represents comparison between the tone value of each target pixel and a threshold value stored at the corresponding position in the dither matrix. When the tone value of the target pixel is greater than the corresponding threshold value in the dither matrix, the process specifies the target pixel as a dot-on pixel, in which a dot is to be created. When the tone value of the target pixel is smaller than the corresponding threshold value in the dither matrix, on the contrary, the process specifies the target pixel as a dot-off pixel, in which no dot is to be created. In the illustrated example of FIG. 10, the tone value allocated to a pixel on the upper left corner of image data is ‘97’, while the threshold value stored at the corresponding position in the dither matrix is ‘1’. Since the tone value of the image data is greater than the corresponding threshold value, the target pixel is specified as a dot-on pixel. Each arrow of the solid line in FIG. 10 represents a process of specifying a dot-on pixel and writing the result of specification at a corresponding position in a memory. An adjoining pixel on the right side of the upper left pixel also has the tone value ‘97’, while the corresponding threshold value in the dither matrix is ‘177’. The threshold value is greater than the tone value, so that the process specifies the target pixel as a dot-off pixel. In this manner, the process refers to the dither matrix and determines the dot on-off state in each target pixel at step S204 in the flowchart of FIG. 8.

The number data generation process then determines whether the above series of processing has been concluded with respect to all the pixels in the pixel group (step S206). When the pixel group still has any unprocessed pixel (step S206: No), the process returns to step S202 and repeats the above series of processing. When the dot on-off state has been determined with respect to all the pixels in the pixel group (step S206: Yes), on the other hand, the process detects the number of dots to be created in the pixel group as number data and stores the number data mapped to the pixel group into the memory (step S208). In the illustrated example of FIG. 10, three pixels are specified as dot-on pixels in the pixel group on the upper left corner of the image data. The number data representing the number ‘3’ of dots to be created in the pixel group is stored into the memory.

After conclusion of the processing with regard to one pixel group, the process subsequently determines whether the processing has been completed with regard to all the pixels included in image data (step S210). When there is any unprocessed pixel, the process returns to step S200 to set a next pixel group, repeats the above series of processing to generate number data representing the number of dots to be created in the next pixel group, and stores the number data (step S208). When the processing has been completed with regard to all the pixels in the image data (step S210: Yes), on the other hand, the process outputs the number data stored in units of pixel groups to the printer 200 (step S212). The number data generation process of FIG. 8 then terminates.

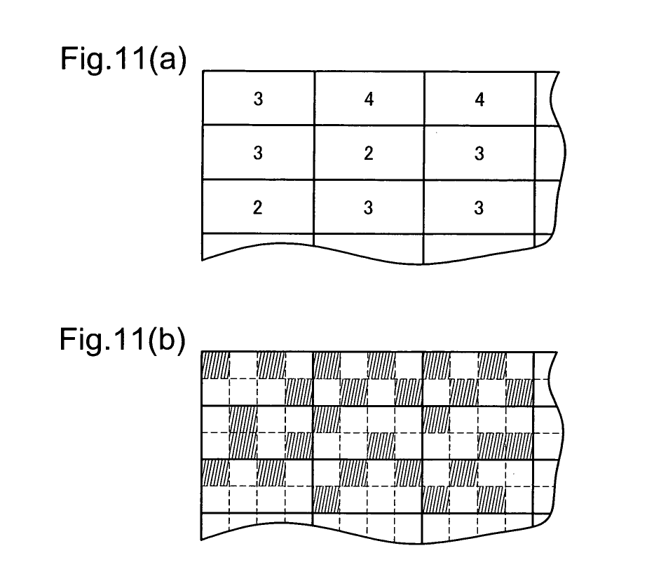

FIG. 11(a) conceptually shows number data generated from the image data by the number data generation process discussed above. Each of multiple rectangles represents a pixel group, and a numeral shown in each pixel group denotes storage of the number of dots to be created in the pixel group. In the system of this embodiment, the computer 100 converts color-converted image data into number data as shown in FIG. 11(a) and outputs only the number data stored in units of pixel groups to the printer 200. Output of the number data desirably reduces the data volume and thus ensures quicker data output, compared with output of the data representing the dot on-off state in the respective pixels (the dot data), as discussed below.

FIG. 11(b) shows the dot on-off state determined with regard to respective pixels in multiple pixel groups. The thin broken lines in FIG. 11(b) show that each pixel group consists of multiple pixels. Each square filled with slant lines represents a dot-on pixel where a dot is to be created.

It is assumed that the computer 100 outputs the dot data shown in FIG. 11(b) to the printer 200. When there is only one type of dot, each pixel takes only either of the two states, that is, the dot-on state or the dot-off state. The data volume required for each pixel is accordingly 1 bit. Since each pixel group consists of eight pixels, the dot data output to the printer 200 uses the volume of 8 bits with respect to each pixel group.

The number data output to the printer 200, on the other hand, uses the volume of only 4 bits with respect to each pixel group, since the number of dots to be created in one pixel group varies in the range of 0 to 8. This desirably halves the required data volume, compared with output of the dot data representing the dot on-off state in the respective pixels. Output of the number data thus attains quicker data output to the printer 200.

The number data transferred from the computer 100 goes through the number data decoding process, which is executed by the control circuit 260 of the printer 200 as discussed below, to be converted into the dot data representing the dot on-off state in the respective pixels and is output as control data to the ink ejection heads 244 through 247.

### E. Number Data Decoding Process

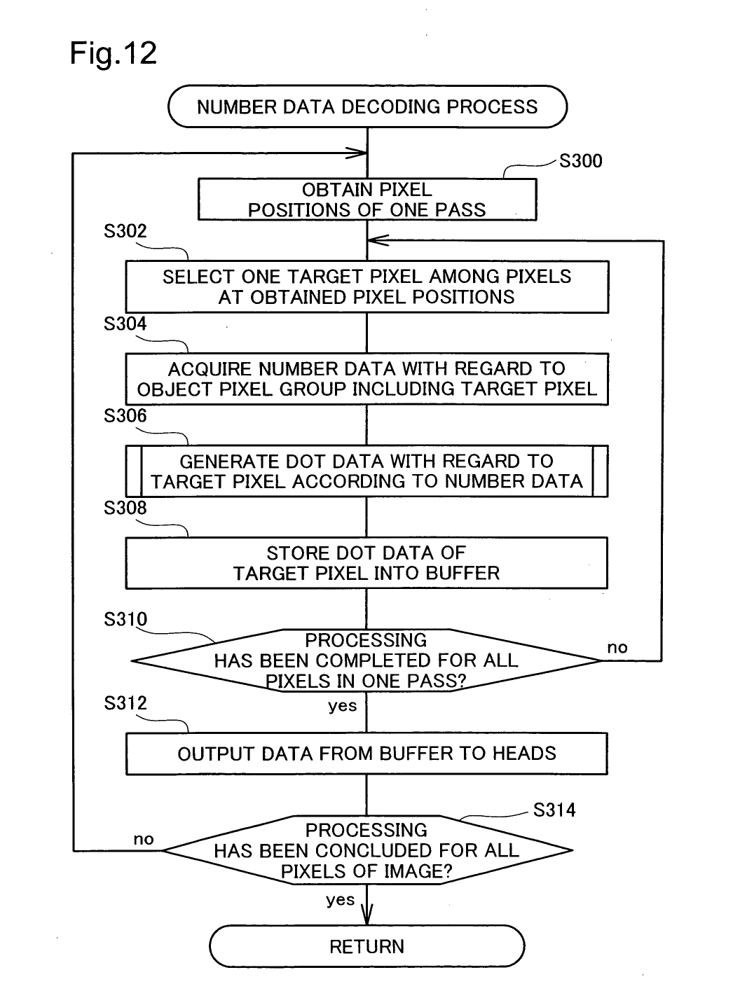

FIG. 12 is a flowchart showing the details of the number data decoding process of the embodiment, which is executed by the internal CPU of the control circuit 260 in the printer 200. The printer 200 of this embodiment executes this processing flow to decode the received number data and accordingly does not require a large storage capacity.

When the number data decoding process starts, the CPU of the control circuit 260 first obtains pixel positions of one pass (step S300). As described above, the printer 200 reciprocates the print head 241 in the main scanning direction while driving the ink ejection heads 244 through 247 to create dots and print a resulting image. The terminology ‘pass’ means reciprocating motion of the print head 241 in the main scanning direction, and ‘1 pass’ represents one reciprocating motion in the main scanning direction. In theory, one array of dots aligned in the main scanning direction (one raster line) is formable by one pass, that is, one reciprocating motion of the print head 241 in the main scanning direction with creating dots. In order to ensure the sufficiently high picture quality, however, it is preferable to form one raster line not by one pass but by multiple passes, that is, by multiple reciprocating motions. In this raster formation technique, some dots present on one raster line are formed by one pass, while other dots on the same raster line are formed by another pass. This is described with reference to a concrete example.

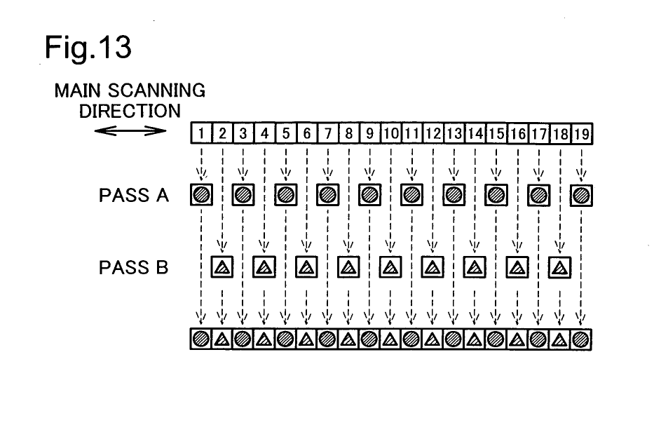

FIG. 13 conceptually shows a process of forming one raster line by two reciprocating motions (that is, by 2 passes). Each small square represents a pixel in the illustration. It is here assumed that a raster line is formed in an array of pixels shown on the top of FIG. 13. As a matter of convenience, respective pixels are discriminated by pixel numbers allocated thereto. Namely digits written in the respective pixels in FIG. 13 are pixel numbers. In the system of completing each raster line by 2 passes, each pass creates dots in alternate pixels. In the illustrated example of FIG. 13, pass A creates dots in pixels of odd pixel numbers, whereas pass B creates dots in pixels of even pixel numbers. For the better understanding, the dots created in pass A are shown by hatched circles, and the dots created in pas B are shown by hatched triangles. Each pass creates dots in pixels at preset intervals in this manner, and one raster line is completed at the end of 2 passes as shown on the bottom of FIG. 13.

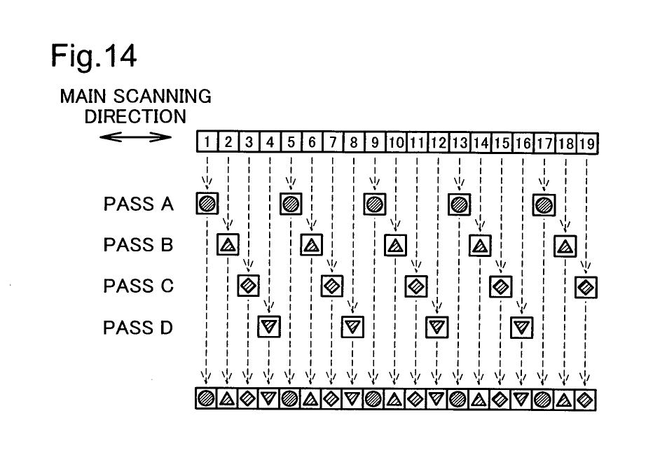

FIG. 14 conceptually shows a process of forming one raster line by 4 passes. In this illustrated example, pass A creates dots in pixels 1, 5, 9, 13, 17, . . . , pass B creates dots in pixels 2, 6, 10, 14, 18, . . . , pass C creates dots in pixels 3, 7, 11, 15, 19, . . . , and pass D creates dots in pixels 4, 8, 12, 16, 20, . . . . Each pass creates dots in pixels at preset intervals in this manner, and one raster line is completed at the end of 4 passes as shown on the bottom of FIG. 14.

The printer 200 creates dots in pixels at preset intervals in each pass and completes each raster line by multiple passes. As described previously with reference to FIG. 5, creation of dots follows the control data supplied from the drive buffer 261 to the respective nozzles. In order to create dots by different passes in pixels on an identical raster line, control data are thus supplied separately from the drive buffer 261 to the nozzles.

Because of this reason, at step S300 in the flowchart of FIG. 12, the CPU obtains the pixel positions of one pass for setting the control data in the drive buffer 261. The CPU obtains the pixel numbers 1, 3, 5, . . . , as the pixel positions of pass A in the example of FIG. 13, and the pixel numbers 2, 6, 10, 14, . . . , as the pixel positions of pass B in the example of FIG. 14.

The CPU subsequently selects one object pixel to be processed (target pixel) among the pixels at the obtained pixel positions (step S302) and acquires number data of an object pixel group including the selected target pixel (step S304). As described previously, the printer 200 of the embodiment receives the number data supplied in units of pixel groups. The CPU accordingly selects the number data with regard to the object pixel group including the target pixels out of the received number data. This number data acquisition step is described concretely with reference to some drawings.

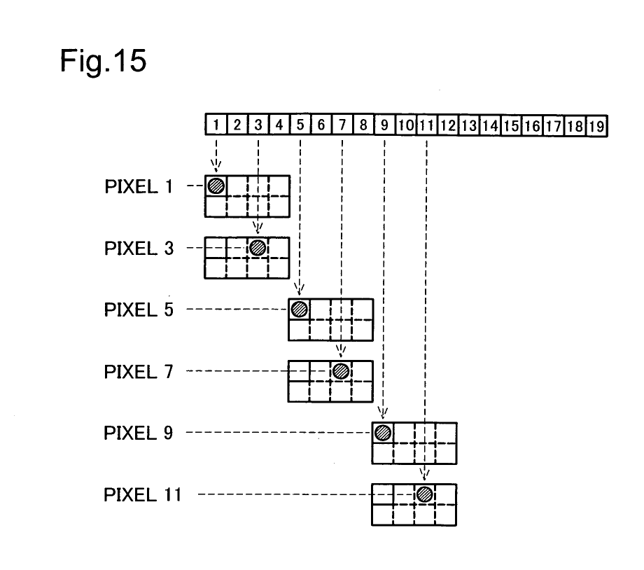

FIG. 15 conceptually shows selection of an object pixel group including a target pixel in the system of completing one raster line by 2 passes. This illustrated example corresponds to creation of dots in pass A of FIG. 13. Each pixel group consists of 8 pixels, that is, 4 columns in the vertical direction and 2 rows in the horizontal direction as shown in FIG. 7(b).

As described above, pass A of FIG. 13 creates dots in the pixels of the pixel numbers 1, 3, 5, 7, 9, . . . . When the selected target pixel is the pixel of the pixel number 1, as shown in FIG. 15, the CPU acquires number data with regard to a left-most pixel group, which includes the pixel of the pixel number 1, at step S304 in the flowchart of FIG. 12. When the selected target pixel is the pixel of the pixel number 3, the CPU acquires the number data with regard to the same left-most pixel group, which also includes the pixel of the pixel number 3. When the selected target pixel is the pixel of the pixel number 5 or the pixel of the pixel number 7, the CPU acquires number data with regard to a second left pixel group. In a similar manner, when the selected target pixel is the pixel of the pixel number 9 or the pixel of the pixel number 11, the CPU acquires number data with regard to a third left pixel group.

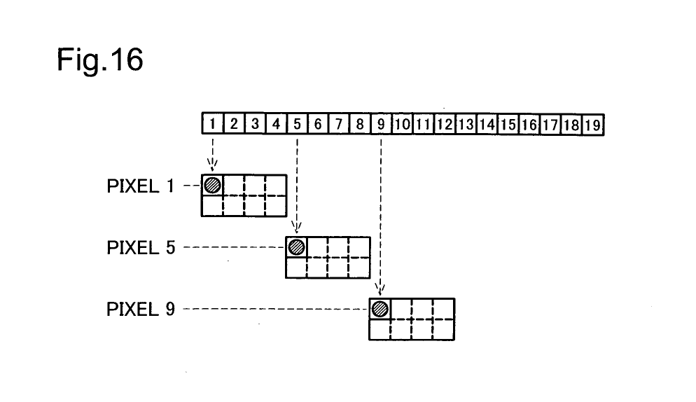

FIG. 16 conceptually shows selection of an object pixel group including a target pixel in the system of completing one raster line by 4 passes. This illustrated example corresponds to creation of dots in pass A of FIG. 14. In this system, when the selected target pixel is the pixel of the pixel number 1, the CPU acquires number data with regard to a left-most pixel group. When the selected target pixel is the pixel of the pixel number 2, the CPU acquires number data with regard to a second left pixel group. When the selected target pixel is the pixel of the pixel number 3, the CPU acquires number data with regard to a third left pixel group. In this manner, the CPU acquires number data with regard to an object pixel group including each selected target pixel at step S304 in the flowchart of FIG. 12.

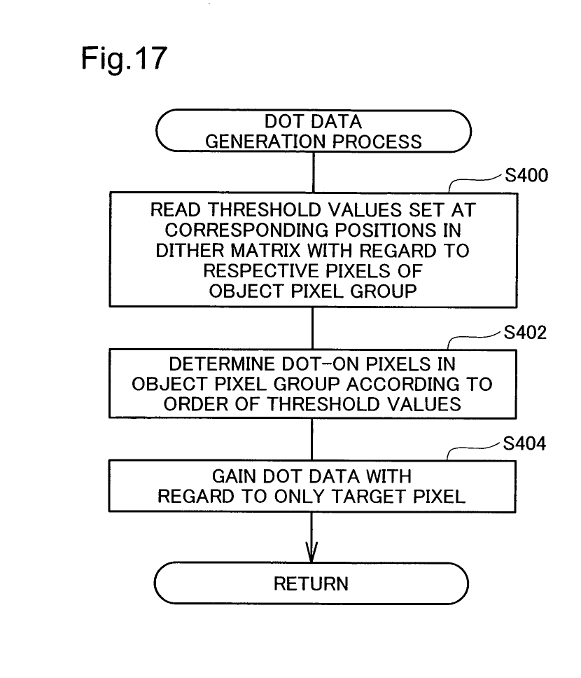

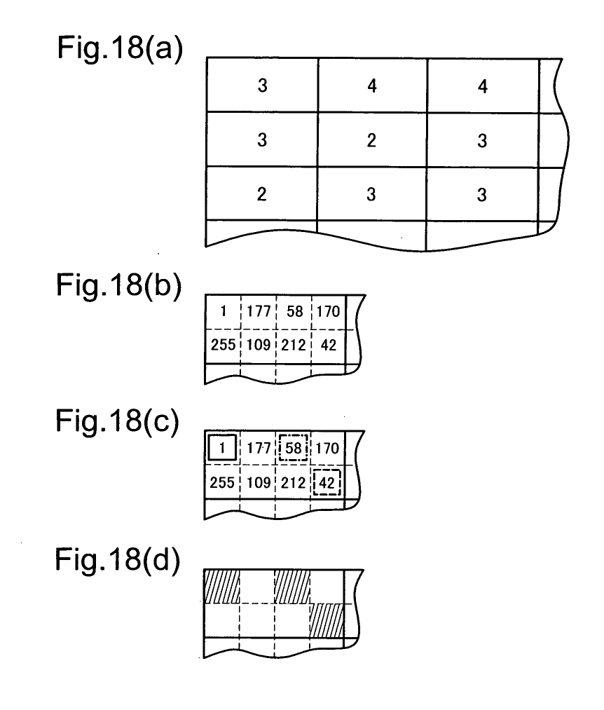

After acquiring the number data, the CPU generates data representing the dot on-off state in the selected target pixel (dot data) (step S306 in FIG. 12). The dot data of the target pixel is generated according to the acquired number data. FIG. 17 is a flowchart showing the details of the processing flow to generate the dot data according to the acquired number data. FIG. 18 conceptually shows generation of the dot data according to the number data. The routine of generating the dot data of the target pixel according to the acquired number data is described in detail with reference to FIGS. 17 and 18.

When the dot data generation routine starts, the CPU first obtains threshold values corresponding to the respective pixels in the object pixel group including the selected target pixel, from a dither matrix (step S400). As described previously, the number data representing the number of dots to be created in one pixel group is generated as a result of comparison between the tone values of respective pixels and threshold values at the corresponding positions in the dither matrix (see FIGS. 8 to 10). At this step in the processing flow, the CPU reads the threshold values, which correspond to the respective pixels in the object pixel group including the target pixel, from the dither matrix.

The CPU then determines dot-on pixels in the object pixel group including the target pixel (step S402). The dot-on pixels in the object pixel group are determined, based on the threshold values of the dither matrix corresponding to the respective pixels in the object pixel group and the number data with regard to the object pixel group. This procedure is described in detail with reference to an example of FIG. 18.

FIG. 18 (a) conceptually shows storage of number data with regard to each pixel group, which has been received from the computer 100, in the RAM 260a of the control circuit 260 of the printer 200. Here it is assumed that the object pixel group including the target pixel is a pixel group on an upper left corner of FIG. 18(a). FIG. 18 (b) conceptually shows settings of threshold values read from the corresponding positions of the dither matrix with regard to the respective pixels in the object pixel group including the target pixel. The threshold values shown in FIG. 18(b) represent the order of the potential for dot creation in the object pixel group. As described previously with reference to FIG. 10, the dot on-off state determination process compares a tone value of a target pixel in the image data with a threshold value at the corresponding position in the dither matrix and specifies the target pixel as a dot-on pixel when the tone value is greater than the corresponding threshold value. Namely the pixels having the smaller threshold values of the dither matrix in FIG. 18(b) have the higher potentials for dot creation. Namely the ascending order of the threshold values in the dither matrix is equivalent to the order of the potential for dot creation.

The number data of FIG. 18(a) shows that three dots are to be created in the object pixel group including the target pixel (that is, the pixel group on the upper left corner). According to the ascending order of the threshold values in FIG. 18(b), three dots are to be created in a pixel of a smallest most threshold value surrounded by the solid line, a pixel of a second smallest threshold value surrounded by the doted line, and a pixel of a third smallest threshold value surrounded by the one-dot chain line as shown in FIG. 18(c). FIG. 18(d) conceptually shows dot data with regard to the respective pixels in the object pixel group generated by conversion of the number data.

Referring back to the flowchart of FIG. 17, the CPU converts the number data into dot data to determine the dot-on pixels in the object pixel group at step S402.

On completion of conversion of the number data into dot data with regard to the respective pixels in the object pixel group, the CPU gains dot data with regard to only the target pixel (step S404). When the target pixel is a dot-on pixel, the given dot data is ‘1’. When the target pixel is a dot-off pixel, on the other hand, the given dot data is ‘0’. After gaining the dot data with regard to the target pixel, the program exits from the dot data generation process of FIG. 17 and goes back to the number data decoding process of FIG. 12.

On the return from the dot data generation routine to the number data decoding routine, the CPU stores the gained dot data with regard to the target pixel into the drive buffer 261 (step S308). The dot data ‘1’ is stored for the dot-on target pixel, while the dot data ‘0’ is stored for the dot-off target pixel.

The CPU subsequently determines whether the processing of writing the dot data into the drive buffer 261 has been completed for all the pixels included in one pass acquired at step S300 (step S310). When the processing has not yet been completed for all the pixel in one pass (step S310: No), the program goes back to step S302 and subsequent steps to select a new pixel as a next target pixel, carry out the subsequent series of processing, and write the generated dot data with regard to the new target pixel into the drive buffer 261. The CPU then determines again whether the processing has been completed for all the pixels in one pass (step S310).

When the processing is repeatedly executed and is eventually completed for all the pixels in one pass acquired at step S300 (step S310: Yes), the dot data for one pass stored in the drive buffer 261 are output as control data to the ink ejection heads 244 to 247 (step S312). As described previously with reference to FIG. 5, while the ink ejection heads are reciprocated in the main scanning direction, ink droplets are ejected according to the control data to create ink dots on the printing medium.

After creation of dots in one pass, the CPU determines whether the processing has been concluded for all the pixels included in the image (step S314). When the processing has been concluded for all the pixels (step S314: Yes), this means that printing of the image has been completed. The program accordingly exits from the number data decoding routine of FIG. 12. When there is any unprocessed pixel (step S314: No), on the other hand, the program returns to step S300 and subsequent steps to acquire pixel positions of one newly selected pass and carry out the above series of processing with regard to pixels at the acquired pixel positions. When the processing is repeatedly executed and is eventually completed for all the pixels of the image, the program exits from the number data decoding routine and goes back to the image printing routine of FIG. 6.

As described above, the printer 200 of the embodiment receives the number data from the computer 100, acquires pixel positions included in one pass, expands number data into dot data, and stores the dot data with regard to only the pixels included in the pass into the drive buffer 261. The dot data thus stored are output as control data from the drive buffer 261 to the respective ink ejection heads 244 to 247, and dots in one pass are created according to the control data. This series of processing is repeated to create dots in each newly selected pass. The number data with regard to every pass is accordingly expanded to dot data and is stored in the drive buffer 261. The printer 200 is accordingly required to have the drive buffer 261 and the memory for storage of the number data received from the computer 100. There is no need of storing all the dot data obtained by conversion of the number data in the memory of the printer 200. This arrangement thus significantly saves the storage capacity of the memory mounted on the printer 200. In the structure of this embodiment, the number data is stored in the RAM 260a of the control circuit 260.

### F. Modifications

The embodiment described above may be modified in various ways. Some possible modification are given below.

(1) First Modification

The procedure of the above embodiment generates the dot data with regard to the respective pixels in each object pixel group including a target pixel and selects only the dot data with regard to the target pixel in the dot data generation process, in order to store the dot data with regard to the target pixel into the drive buffer 261. The dot data of only the target pixel is stored in the drive buffer 261. The procedure may thus convert the number data with regard to only the target pixel into the dot data, in place of generation of the dot data with regard to all the pixels in the object pixel group including the target pixel. Such modification is described below as a first modification.

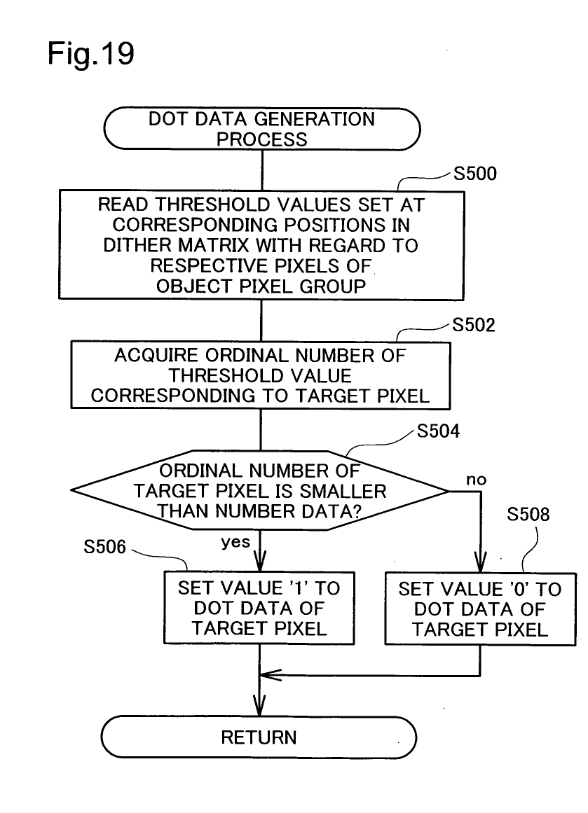

FIG. 19 is a flowchart showing a dot data generation process in the first modification. The primary difference from the dot data generation process of the embodiment shown in FIG. 17 is generation of dot data only with regard to the target pixel. The difference is described in detail with reference to this flowchart.

The dot data generation routine of the first modification first refers to the dither matrix and reads the threshold values corresponding to the respective pixels in an object pixel group including a target pixel (step S500), in a similar manner to the dot data generation routine of the embodiment shown in FIG. 17. The target pixel represents an object pixel selected to be processed at step S302 in the number data decoding process of FIG. 12.

The dot data generation routine of the first modification subsequently acquires an ordinal number of a threshold value corresponding to the target pixel (step S502). Namely the CPU specifies the ordinal number of the threshold value in the ascending order corresponding to the target pixel among the multiple threshold values read from the dither matrix. For example, when the threshold value corresponding to the target pixel is the smallest most among the multiple threshold values, the ordinal number of the threshold value is No. 1. When the threshold value corresponding to the target pixel is the second smallest, the ordinal number of the threshold value is No. 2.

The routine then compares the ordinal number of the threshold value thus acquired with number data of the object pixel group (step S504). The number data of the object pixel group represents the number of dots to be created in the object pixel group including the target pixel, and is acquired at step S304 in the number data decoding process of FIG. 12. When the ordinal number of the threshold value corresponding to the target pixel is smaller than the number data of the object pixel group (step S504: Yes), the routine specifies the target pixel as a dot-on pixel and sets the dot data ‘1’ (step S506). For example, the ordinal number 2 of the threshold value corresponding to the target pixel and the number data ‘3’ of the object pixel group mean that the target pixel has the second highest potential for dot creation in the object pixel group and that the total of three dots are to be created in the object pixel group. The target pixel is thus specified as a dot-on pixel, and the value ‘1’ representing the dot-on state is set to the dot data of the target pixel.

When the ordinal number of the threshold value corresponding to the target pixel is greater than the number data of the object pixel group (step S504: No), for example, when the ordinal number of the threshold value is 4 and the number data is ‘3’, on the other hand, the routine specifies the target pixel as a dot-off pixel. In this case, the value ‘0’ representing the dot-off state is set to the dot data of the target pixel (step S508)

On completion of setting the dot data with regard to the target pixel, the program exits from the dot data generation process in the first modification and goes back to the number data decoding process of FIG. 12.

As described above, the dot data generation process of the first modification immediately specifies the dot data of the target pixel, based on the ordinal number of the threshold value corresponding to the target pixel and the number data of the object pixel group. This modified process does not convert the number data into the dot data with regard to all the pixels included in the object pixel group, thus desirably attaining the high-speed processing and reducing the temporary memory capacity required for the processing.

(2) Second Modification

The procedure of the above embodiment reads the threshold values from the dither matrix and specifies the dot-on pixels in the process of conversion of number data into dot data. The absolute threshold value is, however, not essential for determination of the dot-on pixels in each object pixel group. The only requirement is the order of the threshold values, that is, the order of the potential for dot creation. Storage of the dither matrix may thus be replaced by storage of the order of the potential for dot creation in each pixel group. Conversion of the number data into dot data is carried out according to this order of the potential for dot creation. Such modification is described below as a second modification.

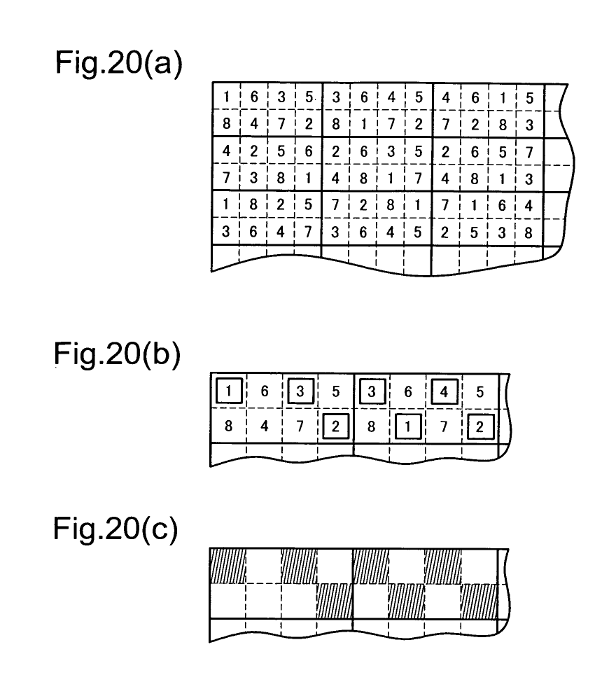

FIG. 20 conceptually shows conversion of number data into dot data in the second modification. FIG. 20(a) shows the settings of the order of the potential for dot creation in respective pixels of each pixel group. For example, the pixel with numeral ‘1’ in each pixel group means the pixel having the highest potential for dot creation in the pixel group.

The number data is readily converted into dot data according to the ordinal numbers of the pixels in each pixel group. For example, in the illustrated example of FIG. 20(b), with regard to a pixel group having the number data ‘3’, dots are to be created in pixels having the first to the third ordinal numbers in the pixel group. In another example, with regard to a pixel group having the number data ‘4’, dots are to be created in pixels having the first to the fourth ordinal numbers in the pixel group. Dot-on pixels are successively determined in respective pixel groups in this manner; so that number data is eventually converted into dot data as shown in FIG. 20(c). The hatched pixels in FIG. 20(c) represent dot-on pixels.

The procedure of the above embodiment reads the threshold values corresponding to the respective pixels in the object pixel group, from the dither matrix and sets the ordinal number of the target pixel by comparison of these threshold values. The procedure of the second modification, however, reads the ordinal number of the target pixel immediately and thereby attains the high-speed conversion of the number data into dot data.

The threshold values in the dither matrix range from 0 to 255, while the ordinal numbers cover only the range of 1 to the number of pixels included in each pixel group. Storage of the dither matrix may thus be replaced by storage of the ordinal numbers of the respective pixels included in each pixel group. Such modification advantageously reduces the memory capacity required for storage.

The embodiment and its modifications discussed above are to be considered in all aspects as illustrative and not restrictive. There may be many modifications, changes, and alterations without departing from the scope or spirit of the main characteristics of the present invention. Some examples of possible modification are given below. For example, software programs (application programs) for attaining the respective functions described above may be received via a communication line and stored in a main memory or an external storage device of a computer system to be executed by the computer system. The software programs may be read from any of CD-ROMs, DVDs, and flexible disks to be executed.

The printing device is not restricted to any of the inkjet printers, but the principle of the invention is also applicable to any thermal transfer printers and dye sublimation printers. The terminology printer includes a personal printing device that prints a large number of images in response to one data transfer and a large printer that prints images in full-size. The printing system of the invention is not limited to the completely separating configuration into the computer as the image processing device and the printer as the printing device, but may have another configuration where the image processing device that executes image processing and the printing device that executes printing are placed in one identical casing. The image processing device and the printing device may not be connected directly via a cable but may be connected via a (wired or wireless) network or by wireless personal area network technology like Bluetooth (trademark). The data transfer between the image processing device and the printing device may be carried out by serial communication or by parallel communication.

In the embodiment described above, each pixel group has 4×2=8 pixels. The pixel group is, however, not restricted to these dimensions, but may have any other suitable dimensions, for example, 3×3, 2×2, or 1×4. The rectangular shape of the pixel group is also not restrictive in any sense. Pixels may be selected in any combination to constitute each pixel group, as long as the whole image data are eventually covered. A complete pixel group may not be set at an end of the image. In such cases, the presence of dummy data is assumed in the periphery of the image data. When original image data has a specific tendency or characteristic, each pixel group may be set to have the shape and the dimensions suitable for the specific tendency or characteristic. For example, in the case of an image having integrally-multiplied resolutions in the vertical direction, a long pixel group consisting of pixels aligned in the vertical direction is advantageous for the better picture quality of a reproduced image. As another example, in the case of an image having a screen angle for printing, a pixel group consisting of multiple pixels aligned at the screen angle is advantageous.

The embodiment described above uses the RAM 260a as the memory for storing dot data. The RAM 260a may be replaced by any conventional semiconductor memory like a static RAM or a dynamic RAM or a cache memory built in a CPU or connecting with a bus of the CPU. The technique of the invention desirably saves the memory capacity and thus facilitates application of a high-speed (generally expensive) memory to the memory of the printer 200 as the printing device. This further ensures the high-speed processing.

1. A printing system comprising an image processing device that processes an image data and a printing device that creates dots on a printing medium according to the processed image data,
wherein the image processing device comprises:
a dot number determination module that determines a number of dots to be created in each pixel group, which is set to have a predetermined number of multiple pixels from among pixels constituting an image, according to the image data; and
a number data output module that outputs number data, which represents the determined number of dots to be created in the pixel group, to the printing device, and
the printing device comprises:
a head that makes a reciprocating motion relative to the printing medium to create plural dots simultaneously at predetermined intervals and repeats the reciprocating motion a preset number of times to complete a raster line as an array of aligned dots;
a pixel set detection module that detects plural pixels, which are processed simultaneously by each reciprocating motion of the head for dot creation, and specifies the detected plural pixels as a pixel set corresponding to the reciprocating motion of the head;
a number data storage module that receives the output number data from the image processing device and stores the received number data;
a dot data storage module that converts the stored number data into dot data representing a dot on-off state in each pixel, and stores the dot data with regard to the respective pixels included in the specified pixel set;
a dot data supply module that supplies the stored dot data to the head in synchronism with the reciprocating motion of the head; and
a dot creation module that drives the head according to the supplied dot data, so as to create dots on the printing medium.

2. A printing system in accordance with claim 1, wherein the dot data storage module converts the number data into the dot data, based on ordinal numbers allocated to the respective pixels in each pixel group for dot creation.

3. A printing system in accordance with claims 1 or 2, wherein the dot data storage module converts the number data into the dot data with regard to all the pixels included in the pixel group and stores the dot data of the respective pixels included in the specified pixel set.

4. A printing system in accordance with claims 1 or 2, wherein the dot data storage module selects a pixel included in the specified pixel set among the multiple pixels of the pixel group, and converts the number data into the dot data with regard to the selected pixel.

5. A printing system in accordance with claim 1, wherein each pixel group consists of four pixels in a raster direction or a direction of the raster line and two pixels in a direction perpendicular to the raster direction, that is, a total of eight pixels.

6. A printing system in accordance with claim 1, wherein the printing device is a color inkjet printer.

7. A printing device that prints an image, the printing device comprising:
a head for printing that makes a reciprocating motion relative to a printing medium to create plural dots simultaneously at predetermined intervals and repeats the reciprocating motion a preset number of times to complete a raster line as an array of aligned dots;
a number data storage module that receives and stores number data representing a number of dots to be created in each pixel group, which is set to have a predetermined number of multiple pixels included in the image;
a pixel set detection module that detects plural pixels, which are processed simultaneously by each reciprocating motion of the head for dot creation, and specifies the detected plural pixels as a pixel set corresponding to the reciprocating motion of the head;
a dot data storage module that converts the stored number data into dot data representing a dot on-off state in each pixel, and stores the dot data with regard to the respective pixels included in the specified pixel set;
a dot data supply module that supplies the stored dot data to the head in synchronism with the reciprocating motion of the head; and
a dot creation module that drives the head according to the supplied dot data, so as to create dots on the printing medium.

8. A printing device in accordance with claim 7, wherein the dot data storage module converts the number data into the dot data, based on ordinal numbers allocated to the respective pixels in each pixel group for dot creation, and stores the dot data.

9. A printing device in accordance with claim 7, wherein each pixel group consists of eight pixels constructed from four pixels in a raster direction and two pixels in a direction perpendicular to the raster direction.

10. A printing device in accordance with claim 7, wherein the head is capable of ejecting at least cyan, magenta, and yellow inks onto the printing medium.

11. A printing method that prints an image, using a head, which makes a reciprocating motion relative to a printing medium to create plural dots simultaneously at predetermined intervals, according to image data and repeating the reciprocating motion a preset number of times to complete a raster line as an array of aligned dots, the printing method comprising:
determining a number of dots to be created in each pixel group according to the image data, where the pixel group is set to have a predetermined number of multiple pixels included in the image;
storing the determined number of dots with regard to the pixel group;
detecting plural pixels, which are processed simultaneously by each reciprocating motion of the head for dot creation, and specifying the detected plural pixels as a pixel set corresponding to the reciprocating motion of the head;
generating dot data representing a dot on-off state in each pixel, based on the number of dots stored with regard to the pixel group, and storing the dot data of the respective pixels included in the specified pixel set;
supplying the stored dot data to the head in synchronism with the reciprocating motion of the head; and
driving the head according to the supplied dot data, so as to create dots on the printing medium.

12. A printing method that makes a reciprocating motion of a head relative to a printing medium to create plural dots simultaneously at predetermined intervals and repeating the reciprocating motion a preset number of times to complete a raster line as an array of aligned dots so as to print an image, the printing method comprising:
receiving and storing number data representing a number of dots to be created in each pixel group, which is set to have a predetermined number of multiple pixels included in the image;
detecting plural pixels, which are processed simultaneously by each reciprocating motion of the head for dot creation, and specifying the detected plural pixels as a pixel set corresponding to the reciprocating motion of the head;
converting the stored number data into dot data representing a dot on-off state in each pixel, and storing the dot data with regard to the respective pixels included in the specified pixel set;
supplying the stored dot data to the head in synchronism with the reciprocating motion of the head; and
driving the head according to the supplied dot data, so as to create dots on the printing medium.

13. A computer program product that records a program code, which causes a computer to print an image, in a recording medium,
wherein the program code comprises:
a code of driving a head, which makes a reciprocating motion relative to a printing medium to create plural dots simultaneously at predetermined intervals, according to image data and repeating the reciprocating motion a preset number of times to complete a raster line as an array of aligned dots,
a first program code of determining a number of dots to be created in each pixel group according to the image data, where the pixel group is set to have a predetermined number of multiple pixels included in the image;
a second program code of storing the determined number of dots with regard to the pixel group;
a third program code of detecting plural pixels, which are processed simultaneously by each reciprocating motion of the head for dot creation, and specifying the detected plural as a pixel set corresponding to the reciprocating motion of the head;
a fourth program code of generating dot data representing a dot on-off state in each pixel, based on the number of dots stored with regard to the pixel group, and storing the dot data of the respective pixels included in the specified pixel set;
a fifth program code of supplying the stored dot data to the head in synchronism with the reciprocating motion of the head; and
a sixth program code of driving the head according to the supplied dot data, so as to create dots on the printing medium.

14. A computer program product that records a program code, which causes a computer to print an image, in a recording medium,
wherein the program code comprises:
a program code of making a reciprocating motion of a head relative to a printing medium to create plural dots simultaneously at predetermined intervals and repeating the reciprocating motion a preset number of times to complete a raster line as an array of aligned dots, a program code (A) of receiving and storing number data representing a number of dots to be created in each pixel group, which is set to have a predetermined number of multiple pixels included in the image;
a program code (B) of detecting plural pixels, which are processed simultaneously by each reciprocating motion of the head for dot creation, and specifying the detected plural pixels as a pixel set corresponding to the reciprocating motion of the head;
a program code (C) of converting the stored number data into dot data representing a dot on-off state in each pixel, and storing the dot data with regard to the respective pixels included in the specified pixel set;
a program code (D) of supplying the stored dot data to the head in synchronism with the reciprocating motion of the head; and
a program code (E) of driving the head according to the supplied dot data, so as to create dots on the printing medium.
